(19) United States
(12) Patent Application Publication
(10) Pub. No.: US 2017/0349737 A1
(43) Pub. Date: Dec. 7, 2017

(54) SILANE CROSSLINKABLE RUBBER COMPOSITION AND SILANE CROSSLINKED RUBBER MOLDED BODY, METHOD OF PRODUCING THE SAME, AND SILANE CROSSLINKED RUBBER MOLDED ARTICLE

(71) Applicant: FURUKAWA ELECTRIC CO., LTD., Tokyo (JP)

(72) Inventors: Hiroki CHIBA, Tokyo (JP); Masaki NISHIGUCHI, Tokyo (JP); Arifumi MATSUMURA, Tokyo (JP); Koichi MIZUNO, Tpkyo (JP)

(73) Assignee: FURUKAWA ELECTRIC CO., LTD., Tokyo (JP)

(21) Appl. No.: 15/686,194

(22) Filed: Aug. 25, 2017

Related U.S. Application Data
(63) Continuation of application No. PCT/JP2016/056387, filed on Mar. 2, 2016.

(30) Foreign Application Priority Data
Mar. 3, 2015 (JP) 2015-041471
Nov. 27, 2015 (JP) 2015-232032

(51) Int. Cl. C08L 23/26; C08J 3/22; C08K 3/22; C08J 3/24; C08K 3/36

(52) U.S. Cl. CPC C08L 23/26; C08J 3/24; C08K 3/36; C08K 3/22; C08J 3/22; C08J 2423/12; C08K 2003/2224; C08J 2423/26

(57) ABSTRACT

A silane crosslinkable rubber composition containing a silane crosslinkable rubber in which a silane coupling agent is grafted onto a base rubber containing 61 to 100 mass % of ethylene-α-olefin rubber having a diene content of 5 mass % or less, and with respect to 100 parts by mass of the base rubber, 0.3 to 400 parts by mass of inorganic filler, and 0.0001 to 0.5 parts by mass of silanol condensation catalyst; a silane crosslinked rubber molded body obtained by bringing the rubber composition into contact with water after molding; a silane crosslinked rubber molded article including the rubber molded body; and a method of producing a silane crosslinkable rubber composition and a silane crosslinked rubber molded body.

### CROSS-REFERENCE TO RELATED APPLICATIONS

This application is a Continuation of PCT International Application No. PCT/JP2016/056387 filed on Mar. 2, 2016, which claims priority under 35 U.S.C. §119 (a) to Japanese Patent Application No. 2015-232032 filed in Japan on Nov. 27, 2015, and Japanese Patent Application No. 2015-41471 filed in Japan on Mar. 3, 2015. Each of the above applications is hereby expressly incorporated by reference, in its entirety, into the present application.

### TECHNICAL FIELD

The present invention relates to a silane crosslinkable rubber composition and a silane crosslinked rubber molded body, a method of producing the same, and a silane crosslinked rubber molded article.

### BACKGROUND ART

For rubber products such as coating materials for various industrial cables (including electric wires) and rubber mold materials (for example, automotive glass run channels, weather strips, rubber hoses, wiper blade rubbers, gaskets and rubber vibration insulators), a compression set is required to be small. The compression set required for these rubber products is also desired to be small even at a high temperature of 100° C. or higher, if a use environment and the like are taken into account.

In a product to be used in an application in which a small compression set is required, a crosslinked EP rubber prepared by vulcanizing (crosslinking) an ethylene-propylene rubber (EP rubber) has been so far used. However, with regard to the crosslinked EP rubber, the EP rubber is required to be vulcanized after being molded.

Consequently, as an alternative material of the EP rubber, studies have been conducted on a thermoplastic rubber crosslinked body (thermal plastic vulcanized, TPV) in which a vulcanization step is unnecessary. This TPV means a material in which a polypropylene-based resin is applied as a sea, and a dynamically crosslinked ethylene-propylene-diene rubber (EPDM) is applied as an island, and both are finely dispersed into a sea-island state. However, the TPV contains the polypropylene-based resin, and has been unable to be satisfied in view of high-temperature characteristics, particularly, heat resistance, and a large compression set at a high temperature. Accordingly, as a raw material for the rubber product in which the compression set at the high temperature (referred to as high-temperature compression set) as described above is required to be small, the EP rubber has been still used.

Specific examples of a method of obtaining the rubber product composed of the EP rubber having the small compression set include an injection molding method described in Patent Literature 1. This method is a method of injection molding a rubber composition containing, as a main component, an ethylene-propylene-based rubber having a specific propylene content and Mooney viscosity (ML (1+4) 100° C.). According to Patent Literature 1, this injection molding method requires primary vulcanization from 1 to 10 minutes, and secondary vulcanization from 30 minutes to 6 hours, for example.

In addition, Patent Literature 2 describes a method of producing a rubber product, in which bloom properties and a compression set are simultaneously improved. According to Patent Literature 2, this production method requires a thermal history for 3 hours or more, preferably 6 hours or more in order to improve the compression set.

Therefore, proposals have been made on a rubber composition from which a rubber product can be produced by vulcanization in a short period of time, although a need for a vulcanization step is not eliminated (see Patent Literature 3). The rubber composition described in Patent Literature 3 is a non-halogen flame retardant rubber composition containing 100 parts by mass of rubber, and 30 to 150 parts by mass of metal hydroxide, in which the rubber is prepared by mixing an ethylene-propylene rubber 1 in which an ethylene proportion is from 60 to 64% with an ethylene-propylene rubber 2 in which an ethylene proportion is from 66 to 70% in a mass ratio of 70:30 to 30:70.

### CITATION LIST

### Patent Literatures

Patent Literature 1: JP-A-8-66931 (“JP-A” means unexamined published Japanese patent application)
Patent Literature 2: JP-A-11-302415
Patent Literature 3: JP-A-2012-241041

### SUMMARY OF INVENTION

### Technical Problem

Also in a non-halogen flame retardant rubber composition described in Patent Literature 3, according to the Examples, a vulcanization step by heating at 160° C. for 20 minutes or 40 minutes is required. Thus, Patent Literatures 1 to 3 all require a step of vulcanizing the rubber (vulcanization facilities having a capability of heating the rubber to a temperature at which the rubber is vulcanized), which has had a problem on productivity.

Incidentally, in outdoor industrial cables among the above-described industrial cables, and among rubber mold materials, in automotive rubber mold materials (automotive glass run channels, rubber hoses, wiper blade rubbers or the like), weather strips, gaskets or the like, some are required to have ozone resistance for suppressing reduction of characteristics caused by ozone, and weather resistance, and also to be excellent in appearance without particulate matters (also referred to as an aggregated substance) protruded on a surface thereof. However, EPDM contains a diene component in a molecule, and therefore is hard to satisfy both the ozone resistance and suppression of the compression set, particularly the compression set at a high temperature (referred to as a high-temperature compression set in several cases). Accordingly, a rubber product to be used in the above-described application is required to have both a small compression set and the ozone resistance.

The present invention is contemplated for overcoming the above-described conventional problems and providing a silane crosslinked rubber molded body that has both a small high-temperature compression set and the ozone resistance, and is excellent also in appearance, and a method of producing the same.

In addition, the present invention is contemplated for providing a silane crosslinkable rubber composition having a capability of producing the above-described silane crosslinked rubber molded body having the above-described characteristics without needing vulcanization facilities and with satisfactory productivity, and a method of producing the same.

Furthermore, the present invention is contemplated for providing a silane crosslinked rubber molded article including the silane crosslinked rubber molded body having such excellent characteristics.

### Solution to Problem

The present inventors found that, if a specific silane crosslinking method is applied to an EP rubber in which a diene content is reduced, in producing a crosslinked rubber molded body using an ethylene-α-olefin rubber, a need for vulcanization facilities for the EP rubber is eliminated, and also a silane crosslinked rubber molded body that simultaneously has a small high-temperature compression set, ozone resistance and excellent appearance can be produced. The present inventors further continued to conduct research based on this finding, and completed the present invention.

Here, the silane crosslinking method for a rubber means a method of obtaining a crosslinked rubber, in which a silane grafted rubber is obtained by allowing a hydrolyzable silane coupling agent having an unsaturated group to perform a grafting reaction onto the rubber in the presence of an organic peroxide, and then the silane grafted rubber is crosslinked through the silane coupling agent by bringing the silane grafted rubber into contact with moisture in the presence of a silanol condensation catalyst.

The above-described problems of the present invention can be solved by the following means.

[1] A silane crosslinkable rubber composition, having:

a silane crosslinkable rubber in which a silane coupling agent is grafted onto a base rubber containing 61 to 100 mass % of ethylene-α-olefin rubber having a diene content of 5 mass % or less, and

with respect to 100 parts by mass of the base rubber, 0.3 to 400 parts by mass of inorganic filler, and 0.0001 to 0.5 parts by mass of silanol condensation catalyst.

[2] The silane crosslinkable rubber composition described in the above item [1], wherein the diene content is 2 mass % or less.
[3] The silane crosslinkable rubber composition described in the above item [1] or [2], wherein the silane crosslinkable rubber composition is obtained by melt-mixing, with respect to 100 parts by mass of the base rubber, 0.3 to 400 parts by mass of the inorganic filler, 1 to 15 parts by mass of the silane coupling agent, 0.01 to 0.6 parts by mass of the organic peroxide, and 0.0001 to 0.5 parts by mass of the silanol condensation catalyst.
[4] The silane crosslinkable rubber composition described in any one of the above items [1] to [3], wherein the inorganic filler is at least one kind selected from the group consisting of metal hydrate, talc, clay, silica, and carbon black.
[5] The silane crosslinkable rubber composition described in any one of the above items [1] to [4], wherein the base rubber contains 1 to 30 mass % of polypropylene-based resin.
[6] The silane crosslinkable rubber composition described in any one of the above items [1] to [5], wherein a content of the silane coupling agent is from 3 to 15 parts by mass with respect to 100 parts by mass of the base rubber.
[7] A silane crosslinked rubber molded body obtained by molding the silane crosslinkable rubber composition described in any one of the above items [1] to [6], and then bringing the resultant material into contact with water.
[8] A silane crosslinked rubber molded article including the silane crosslinked rubber molded body described in the above item [7].
[9] A method of producing a silane crosslinkable rubber composition, having:

step (1): obtaining the silane crosslinkable rubber composition by melt-mixing, with respect to 100 parts by mass of a base rubber containing 61 to 100 mass % of ethylene-α-olefin rubber having a diene content of 5 mass % or less, 0.3 to 400 parts by mass of inorganic filler, 1 to 15 parts by mass of silane coupling agent, 0.01 to 0.6 parts by mass of organic peroxide, and 0.0001 to 0.5 parts by mass of silanol condensation catalyst,

wherein the step (1) has a step (a) and a step (c) below, provided that, when a part of the base rubber is melt-mixed in the step (a), the step (1) has a step (a), a step (b) and a step (c);

step (a): preparing a silane master batch by melt-mixing a whole or part of the base rubber, the inorganic filler, the silane coupling agent and the organic peroxide at a temperature equal to or higher than a decomposition temperature of the organic peroxide;

step (b): preparing a catalyst master batch by melt-mixing a remainder of the base rubber and the silanol condensation catalyst; and

step (c): melt-mixing the silane master batch, and the silanol condensation catalyst or the catalyst master batch.

[10] A method of producing a silane crosslinked rubber molded body, having the following steps (1), (2) and (3):
step (1): obtaining a silane crosslinkable rubber composition by melt-mixing, with respect to 100 parts by mass of a base rubber containing 61 to 100 mass % of ethylene-α-olefin rubber having a diene content of 5 mass % or less, 0.3 to 400 parts by mass of inorganic filler, 1 to 15 parts by mass of silane coupling agent, 0.01 to 0.6 parts by mass of organic peroxide, and 0.0001 to 0.5 parts by mass of silanol condensation catalyst,

step (2): obtaining a molded body by molding the silane crosslinkable rubber composition obtained in the step (1); and

step (3): obtaining a silane crosslinked rubber molded body by bringing the molded body obtained in the step (2) into contact with water,

wherein the step (1) has a step (a) and a step (c) below, provided that, when a part of the base rubber is melt-mixed in the step (a), the step (1) has the step (a), a step (b) and the step (c);

step (a): preparing a silane master batch by melt-mixing a whole or part of the base rubber, the inorganic filler, the silane coupling agent and the organic peroxide at a temperature equal to or higher than a decomposition temperature of the organic peroxide;

step (b): preparing a catalyst master batch by melt-mixing a remainder of the base rubber and the silanol condensation catalyst; and

step (c): melt-mixing the silane master batch, and the silanol condensation catalyst or the catalyst master batch.

Note that, in this specification, numerical expressions in a style of “ . . . to . . . ” will be used to indicate a range including the lower and upper limits represented by the numerals given before and after “to”, respectively.

### Advantageous Effects of Invention

The present invention can provide a silane crosslinked rubber molded body that has both a small high-temperature compression set, and ozone resistance, and is excellent also in appearance, and a method of producing the same. In addition, the present invention can provide a silane crosslinkable rubber composition having a capability of producing the silane crosslinked rubber molded body having such excellent characteristics without needing vulcanization facilities and with satisfactory productivity, and a method of producing the same. Further, the present invention can provide a silane crosslinked rubber molded article including the silane crosslinked rubber molded body having such excellent characteristics.

Other and further features and advantages of the invention will appear more fully from the following description.

### MODE FOR CARRYING OUT THE INVENTION

A silane crosslinkable rubber composition of the present invention contains a silane crosslinkable rubber in which a silane coupling agent is grafted onto a base rubber containing 61 to 100 mass % of ethylene-α-olefin rubber having a diene content of 5 mass % or less, and with respect to 100 parts by mass of the base rubber, 0.3 to 400 parts by mass of inorganic filler and 0.0001 to 0.5 parts by mass of silanol condensation catalyst. This silane crosslinkable rubber composition can be preferably prepared by melt-mixing, with respect to 100 parts by mass of the base rubber, 0.3 to 400 parts by mass of inorganic filler, 1 to 15 parts by mass of silane coupling agent, 0.01 to 0.6 parts by mass of organic peroxide, and 0.0001 to 0.5 parts by mass of silanol condensation catalyst. Thus, as mentioned below, the silane crosslinkable rubber is formed by the silane coupling agent being graft reacted onto the base rubber.

In addition, a silane crosslinked rubber molded body of the present invention can be obtained by molding the silane crosslinkable rubber composition of the present invention, and then bringing the resultant material into contact with water. Thus, as mentioned below, the silane coupling agent in the silane crosslinkable rubber as contained in the silane crosslinkable rubber composition is subjected to a crosslinking reaction with water into a silane crosslinked rubber molded body.

The components used in the present invention are described.

### <Base Rubber>

The base rubber to be used in the present invention contains the ethylene-α-olefin rubber in which the diene content is 5 mass % or less, as a rubber component having a site on which the silane coupling agent can be graft reacted.

The base rubber further may include polypropylene-based resin.

The base rubber further may include rubber component other than the ethylene-α-olefin rubber and resin component other than the polypropylene-based resin. The rubber component other than the ethylene-α-olefin rubber is not particularly limited, and examples thereof include natural rubber (NR), styrene-butadiene rubber (SBR), chloroprene rubber (CR), acrylic rubber (ACM), and silicone rubber (Q). The resin component other than the polypropylene-based resin is not particularly limited, and examples thereof include high-density polyethylene (HDPE), low-density polyethylene (LDPE), linear low-density polyethylene (LLDPE), and ethylene-based copolymer. When the base rubber contains the rubber component and the resin component described above, a content of the rubber component and the resin component each is not particularly limited, and is appropriately determined.

In this base rubber, the content of each rubber component and the content of each resin component are appropriately determined to be 100 mass % in a total of the rubber component and the resin component, and preferably selected from the range described below.

### (Ethylene-α-Olefin Rubber)

The ethylene-α-olefin rubber to be used in the present invention is an ethylene-α-olefin rubber in which an amount of a diene constituent (referred to as the diene content) in the copolymer is 5 mass % or less. If the diene content is excessively large, sufficient ozone resistance is not obtained in several cases. In the present invention, even if the diene content is as small as 5 mass % or less, the ethylene-α-olefin rubber can be crosslinked by silane crosslinking. Therefore, even if the ethylene-α-olefin rubber that is disadvantageous in suppressing the compression set is used, the resultant product has a small compression set even at a high temperature, and can provide the silane crosslinked rubber molded body with excellent ozone resistance and the small compression set in a wide temperature range from an ordinary temperature (service temperature) to a high temperature (hereinafter, referred to as an excellent compression set in several cases). In addition, the molded body can have excellent oil resistance.

Specific examples of the ethylene-α-olefin rubber include a rubber composed of an ethylene-α-olefin copolymer, and preferably a rubber composed of a binary copolymer of ethylene and α-olefin, and a rubber composed of a terpolymer of ethylene, α-olefin and diene. The diene in the terpolymer may be conjugated diene or non-conjugated diene, and non-conjugated diene is preferable. In other words, specific examples of the terpolymer include a terpolymer of ethylene, α-olefin and conjugated diene, and a terpolymer of ethylene, α-olefin and non-conjugated diene. A binary copolymer of ethylene and α-olefin, and a terpolymer of ethylene, α-olefin and non-conjugated diene are preferable.

Specific examples of the conjugated diene include butadiene, isoprene, 1,3-pentadiene, and 2,3-dimethyl-1,3-butadiene, and butadiene is preferable. Specific examples of the non-conjugated diene include dicyclopentadiene (DCPD), ethylidene norbornene (ENB), and 1,4-hexadiene, and ethylidene norbornene is preferable. Each constituent of the conjugated diene and the non-conjugated diene may be used singly, or in combination of two or more kinds thereof.

Specific examples of the α-olefin include an α-olefin having 3 to 12 carbon atoms. The α-olefin is not particularly limited, and examples thereof include propylene, 1-butene, 1-hexene, 4-methyl-1-pentene, 1-octene, 1-decene, 1-dodecene.

Specific examples of the rubber composed of the bipolymer of ethylene and α-olefin include ethylene-propylene rubber, ethylene-butene rubber, and ethylene-octene rubber. Specific examples of the rubber composed of the terpolymer of ethylene, α-olefin, and diene include ethylene-propylene-diene rubber and ethylene-butene-diene rubber.

Among these, ethylene-propylene rubber, ethylene-butene rubber, ethylene-propylene-diene rubber and ethlylene-butene-diene rubber are preferable, ethylene-propylene rubber and ethylene-propylene-diene rubber are more preferable, and ethylene-propylene rubber and ethlylene-propylene-ethylidene norbornene rubber are particularly preferable.

The diene content in the ethylene-α-olefin rubber is 5 mass % or less. If the diene content is excessively large, the resultant product is unable to simultaneously have a small high-temperature compression set, and excellent appearance and ozone resistance. In addition, the product is poor in the oil resistance in several cases. The diene content is preferably 0 to 5 mass %, further preferably 0 to 4 mass %, and still further preferably 0 to 3 mass % in view of the ozone resistance, moldability based on reactivity, or the like. The diene content is particularly preferably 2 mass % or less in view of a capability of keeping the excellent appearance even if an extruder is stopped, and then the operation is resumed, as mentioned later. Meanwhile, the content thereof is preferably from 2 to 5 mass % in view of the high-temperature compression set. The diene content can be measured by infrared absorption spectroscopy (FT-IR), a proton NMR (¹H-NMR) method or the like, for example.

In the ethylene-α-olefin rubber, an amount of an ethylene constituent in the copolymer (referred to as an ethylene content) is preferably from 45 to 80 mass %, further preferably from 50 to 70 mass %, and still further preferably from 50 to 65 mass %. If the ethylene content is in the range from 45 to 80 mass %, the molded body is excellent in the compression set. The ethylene content is a value measured in accordance with the method described in ASTM D3900.

Mooney viscosity of the ethylene-α-olefin rubber is preferably from 20 to 70 (ML (1+4) 125° C.), further preferably from 25 to 65 (ML (1+4) 125° C.), and still further preferably from 30 to 60 (ML (1+4) 125° C.) in view of tensile strength and the moldability.

The Mooney viscosity is measured based on a measuring method specified in JIS (Japanese Industrial Standards) K 6300-1: 2013. A test is conducted as described below. As a test piece to be used, one set including 2 pieces of test samples each having a diameter of about 50 mm and a thickness of about 6 mm is prepared by a method of passing through a roll as described in 5.3.1 in JIS K 6300-1. A disc-shaped L-type rotor made of metal is mounted in a cylindrical hollow part (cavity) that is formed of two dies, and a rubber test piece obtained is filled thereinto. Then, the rotor is rotated under predetermined conditions of a pre-heating time of 1 minute, a rotor rotation time of 4 minutes, and a test temperature of 125° C., torque on the rotor by resistance of the rubber on the above occasion is measured in a Mooney unit as the Mooney viscosity of the rubber.

A content of the ethylene-α-olefin rubber is 61 to 100 mass % in 100 parts by mass of the base rubber. If the content of the ethylene-α-olefin rubber is 61 parts by mass or more, the resultant product can provide the molded body with the above-described excellent characteristics. In the present invention, with regard to the content of the ethylene-α-olefin rubber, a lower limit is preferably from 70 parts by mass, further preferably from 75 parts by mass, and still further preferably from 80 parts by mass. When the base rubber contains the polypropylene-based resin, the content of the ethylene-α-olefin rubber is preferably from 70 to 99 parts by mass, further preferably from 75 to 95 parts by mass, and still further preferably from 80 to 90 parts by mass, in 100 parts by mass of the base rubber, in view of satisfying both the ozone resistance and the compression set.

The ethylene-α-olefin rubber may be used singly, or in combination of two or more kinds thereof. When two or more kinds thereof are simultaneously used, each ethylene-α-olefin rubber preferably satisfies the diene content or the like, but in the present invention, a blend material of two or more kinds of the ethylene-α-olefin rubbers as a whole may satisfy the diene content or the like.

### (Polypropylene-Based Resin)

Polypropylene-based resin (PP) is not particularly limited, as long as the polypropylene-based resin is a resin composed of a polymer containing a propylene component as a constituent. The polypropylene-based resin includes a homopolymer (h-PP) of propylene, random polypropylene (r-PP) being a copolymer with ethylene and/or 1-butene (preferably in a small amount), block polypropylene (b-PP) in which a rubber such as an ethylene rubber is dispersed into h-PP or r-PP, or the like. Among these, random polypropylene is preferable.

A melt flow rate (MFR, 230° C., 21.18 N) of the polypropylene-based resin is not particularly limited, but is preferably from 0.5 to 50 g/10 min, and particularly preferably from 10 to 30 g/10 min. Molding can be performed, by using the polypropylene-based resin having MFR in the above-described range, at a higher linear speed, and the molded body having the excellent appearance can be obtained. MFR (230° C., 21.18 N) is expressed by a value measured under the condition D of 230° C., 21.18 N based on “Procedure A (manual cut-off method)” specified in JIS K 7210.

Specific examples of PP include NOVATEC (registered trademark) PP (manufactured by Japan Polypropylene Corporation), PM940M and PM921V (both trade names, manufactured by SunAllomer Ltd.), SUMITOMO NOBLEN (registered trademark, manufactured by Sumitomo Chemical Co., Ltd.), and Prime Polypro (registered trademark, manufactured by Prime Polymer Co., Ltd.).

When the base rubber contains the polypropylene-based resin, the content of the polypropylene-based resin in the base resin is not particularly limited, but is preferably from 1 to 30 parts by mass, more preferably from 5 to 25 parts by mass, and further preferably from 10 to 20 parts by mass, with respect to 100 parts by mass of the base rubber.

The polypropylene-based resin may be used singly, or in combination of two or more kinds thereof. When two or more kinds thereof are simultaneously used, each polypropylene-based resin preferably satisfies the MFR, but in the present invention, a blend material of two or more kinds of the polypropylene-based resins as a whole may satisfy the MFR.

### <Inorganic Filler>

The inorganic filler to be used in the present invention can be used without particular limitation, as long as the inorganic filler has, on a surface thereof, a site in which the inorganic filler can be chemically bonded on a reaction site of the silane coupling agent by hydrogen bonding, covalent bonding or the like. For the inorganic filler, examples of the site (group) that can be chemically bonded on the reaction site of the silane coupling agent may include an OH group (OH group of hydroxy group, of water molecule in hydrous substance or crystallized water, or of carboxyl group), amino group, a SH group, and the like.

Examples of such an inorganic filler include hydration water and metal hydrates such as a compound having a hydroxy group or crystallized water. Examples of the metal hydrate include metal hydroxides such as aluminum hydroxide, magnesium hydroxide and aluminum oxide hydrate, further, calcium carbonate, magnesium carbonate, calcium silicate, magnesium silicate, calcium oxide, magnesium oxide, aluminum oxide, aluminum nitride, aluminum borate whisker, and also inorganic salts or inorganic oxides having hydration water and the like such as hydrated aluminum silicate, hydrated magnesium silicate, basic magnesium carbonate, and hydrotalcite.

Examples of the inorganic filler other than the metal hydrate include boron nitride, silica (crystalline silica, amorphous silica, or the like), carbon black, clay, zinc oxide, tin oxide, titanium oxide, molybdenum oxide, antimony trioxide, a silicone compound, quartz, talc, zinc borate, white carbon, zinc borate, zinc hydroxystannate, and zinc stannate.

Among these, inorganic filler is, preferably at least one kind selected from the group consisting of metal hydrate, talc, clay, silica, and carbon black.

The inorganic filler may be used singly, or in combination of two or more kinds thereof.

The inorganic filler has an average primary particle diameter of preferably 0.001 to 10 μm, more preferably 0.005 to 5 μm, further preferably 0.01 to 2 μm, and particularly preferably 0.015 to 1 μm. If the average primary particle diameter is within the above-described range, the filler has a high effect of keeping the silane coupling agent, and the molded body has excellent tensile strength or the excellent compression set. In addition, the inorganic filler is hard to cause secondary aggregation during mixing with the silane coupling agent, and the molded body has the excellent appearance. The average primary particle diameter is obtained by dispersing the inorganic filler in alcohol or water, and then measuring using an optical particle diameter measuring device such as a laser diffraction/scattering particle diameter distribution measuring device.

As the inorganic filler, a surface-treated inorganic filler, surface-treated with a silane coupling agent can be used. Specific examples of silane-coupling-agent-surface-treated inorganic filler include KISUMA 5L and KISUMA 5P (both trade names, magnesium hydroxide, manufactured by Kyowa Chemical Industry Co., Ltd.) or the like. The amount of surface treatment of the inorganic filler with a silane coupling agent is not particularly limited, but is 2 mass % or less, for example.

### <Silane Coupling Agent>

The silane coupling agent to be used in the present invention may be an agent at least having a grafting reaction site (a group or an atom) having a capability of being graft reacted onto the base rubber in the presence of a radical generated by decomposition of the organic peroxide, and a reaction site (including a moiety formed by hydrolysis: for example, a silyl ester group or the like) having both a capability of being silanol condensed, and a capability of reacting with the site having a capability of being chemically bonded in the inorganic filler. Among these silane coupling agents, a hydrolyzable silane coupling agent having a hydrolyzable group at an end is preferable. The silane coupling agent is further preferably one having, at an end, a group having an amino group, a glycidyl group, or an ethylenically unsaturated group, and a group having a hydrolyzable group; and still further preferably a silane coupling agent having a group having an ethylenically unsaturated group, and a group having a hydrolyzable group, at an end. The group having an ethylenically unsaturated group is not particularly limited, and specific examples thereof include a vinyl group, an allyl group, a (meth)acryloyloxy group, a (meth)acryloyloxyalkylene group, and a p-styryl group. In addition, these silane coupling agents and a silane coupling agent having any other end group may be simultaneously used.

As such a silane coupling agent, for example, a compound represented by the following Formula (1) can be used.

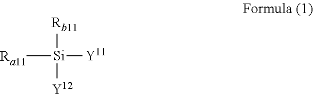

In formula (1), Rₐ₁₁ represents a group having an ethylenically unsaturated group, R_{b11} represents an aliphatic hydrocarbon group, a hydrogen atom, or Y¹³. Y¹¹, Y¹² and Y¹³ each represent a hydrolyzable organic group. Y¹¹, Y¹², and Y¹³ may be the same or different from each other.

Rₐ₁₁ of the silane coupling agent represented by Formula (1) is preferably a group having an ethylenically unsaturated group. The group having an ethylenically unsaturated group is as explained above, and is preferably a vinyl group.

R_{b11} represents an aliphatic hydrocarbon group, a hydrogen atom, or Y¹³ to be described below, and example of the aliphatic hydrocarbon group may include a monovalent aliphatic hydrocarbon group having 1 to 8 carbon atoms other than an aliphatic unsaturated hydrocarbon group. R_{b11} preferably represents Y¹³ to be described below.

Y¹¹, Y¹², and Y¹³ each independently represent a hydrolyzable organic group, and examples thereof may include an alkoxy group having 1 to 6 carbon atoms, an aryloxy group having 6 to 10 carbon atoms, and an acyloxy group having 1 to 4 carbon atoms, and an alkoxy group is preferable. Specific examples of the hydrolyzable organic group may include methoxy, ethoxy, butoxy, and acyloxy. Among them, from the standpoint of the reactivity of the silane coupling agent, methoxy or ethoxy is preferable, and methoxy is more preferable.

As the silane coupling agent, a silane coupling agent that has high hydrolysis rate is preferable, a silane coupling agent in which R_{b11} is Y¹³ and also Y¹¹, Y¹² and Y¹³ are the same each other, or a hydrolyzable silane coupling agent in which at least one of Y¹¹, Y¹², and Y¹³ is a methoxy group, is more preferable, and a silane coupling agent in which R_{b11} is Y¹³ and also Y¹¹, Y¹², and Y¹³ are the same each other is further preferable. A hydrolyzable silane coupling agent in which all of Y¹¹, Y¹², and Y¹³ are methoxy groups is particularly preferable.

Specific examples of the silane coupling agent include vinylsilanes such as vinyltrimethoxysilane, vinyltriethoxysilane, vinyltributoxysilane, vinyldimethoxyethoxysilane, vinyldimethoxybutoxysilane, vinyldiethoxybutoxysilane, allyltrimethoxysilane, allyltriethoxysilane, and vinyltriacetoxysilane, and (meth)acryloxysilanes such as methacryloxypropyltrimethoxysilane, methacryloxypropyltriethoxysilane, and methacryloxypropylmethyldimethoxysilane.

Specific examples of the silane coupling agent having a glycidyl group at an end include 3-glycidoxypropyltriethoxysilane, 3-glycidoxypropylmethyldiethoxysilane, 3-glycidoxypropyltrimethoxysilane, 3-glycidoxypropylmethyldimethoxysilane, and 2-(3,4-epoxycyclohexyl)ethyltrimethoxysilane.

Among the silane coupling agents, the silane coupling agent having a vinyl group and an alkoxy group at an end is preferable, and vinyltrimethoxysilane or vinyltriethoxysilane is more preferable.

The silane coupling agent may be used singly, or in combination of two or more kinds thereof. Further, the silane coupling agent may be used as it is, or may be diluted with a solvent and used.

### <Organic Peroxide>

The organic peroxide plays a role of generating the radical by at least thermal decomposition, and causing, as the catalyst, the grafting reaction by a radical reaction (including a hydrogen radical abstraction reaction from the rubber) of the grafting reaction site of the silane coupling agent onto the base rubber.

The organic peroxide is not particularly limited, as long as the organic peroxide is one that generates a radical. For example, as the organic peroxide, the compound represented by the formula R¹—OO—R², R³—OO—C(═O)R⁴, or R⁵C(═O)—OO(C═O)R⁶ is preferable. Herein, R¹ to R⁶ each independently represent an alkyl group, an aryl group, or an acyl group. Among R¹ to R⁶ of each compound, it is preferable that all of R¹ to R⁶ be an alkyl group, or any one of them be an alkyl group, and the rest be an acyl group.

Examples of such organic peroxide may include dicumyl peroxide (DCP), di-tert-butyl peroxide, 2,5-dimethyl-2,5-di-(tert-butyl peroxy)hexane, 2,5-dimethyl-2,5-di(tert-butyl peroxy)hexyne-3, 1,3-bis(tert-butyl peroxyisopropyl)benzene, 1,1-bis(tert-butyl peroxy)-3,3,5-trimethylcyclohexane, n-butyl-4,4-bis(tert-butyl peroxy)valerate, benzoyl peroxide, p-chlorobenzoyl peroxide, 2,4-dichlorobenzoyl peroxide, tert-butyl peroxybenzoate, tert-butyl peroxyisopropyl carbonate, diacetyl peroxide, lauroyl peroxide, tert-butylcumyl peroxide and the like. Among them, dicumyl peroxide, 2,5-dimethyl-2,5-di-(tert-butyl peroxy)hexane, or 2,5-dimethyl-2,5-di-(tert-butyl peroxy)hexyne-3 is preferable, from the standpoint of odor, coloration, and scorch stability.

The decomposition temperature of the organic peroxide is preferably 130 to 195° C., and more preferably 150 to 185° C.

In the present invention, the decomposition temperature of the organic peroxide means the temperature (half life temperature for 1 minute), at which, when an organic peroxide having a single composition is heated, the organic peroxide itself causes a decomposition reaction and the half amount of the organic peroxide decomposes into two or more kinds of compounds at a certain temperature or temperature range during 1 minute. In specific, the decomposition temperature is a temperature at which heat absorption or exothermic reaction starts, when the organic peroxide is heated at room temperature in a rising rate of 5° C./min under a nitrogen gas atmosphere, by a thermal analysis such as a DSC method.

### <Silanol Condensation Catalyst>

The silanol condensation catalyst has an action of binding the silane coupling agents which have been grafted onto the base rubbers to each other, by a condensation reaction in the presence of water. Based on the action of the silanol condensation catalyst, the rubbers are crosslinked between themselves through silane coupling agent. As a result, the silane crosslinked rubber molded body that has the excellent tensile strength or the small high-temperature compression set, even without using vulcanization facilities, and when necessary, can be molded at a high temperature or a high speed can be obtained in a shorter period of time in comparison with the conventional method of producing the crosslinked EP rubber.

Examples of the silanol condensation catalyst to be used in the present invention include an organic tin compound, a metal soap, a platinum compound, and the like. Usual examples of the silanol condensation catalyst may include dibutyltin dilaurate, dioctyltin dilaurate, dibutyltin dioctylate, dibutyltin diacetate, zinc stearate, lead stearate, barium stearate, calcium stearate, sodium stearate, lead naphthenate, lead sulfate, zinc sulfate, an organic platinum compound, and the like. Among these, organic tin compounds such as dibutyltin dilaurate, dioctyltin dilaurate, dibutyltin dioctylate, and dibutyltin diacetate are particularly preferable.

### <Carrier Rubber>

The silanol condensation catalyst is, if desired, mixed with the rubber, and used. Such a rubber (also referred to as a carrier rubber) is not particularly limited, but each rubber or each resin component described as the base rubber can be used.

### <Additive>

The silane crosslinked rubber molded body and the silane crosslinkable rubber composition may properly contain the various additives which are usually used for the rubber product, in the range that does not adversely affect the effects exhibited by the present invention. Example of these additives includes a crosslinking assistant, an antioxidant, a lubricant, a metal inactivator, a coloring agent, or a filler other than the inorganic filler (including a flame retardant (a flame retardant aid)).

Next, the method of producing the silane crosslinkable rubber composition and the silane crosslinked rubber molded body of the present invention are specifically described.

In both of the “method of producing the silane crosslinked rubber molded body” of the present invention and the “method of producing the silane crosslinkable rubber composition” of the present invention, the step (1) below is conducted. Accordingly, the “method of producing the silane crosslinked rubber molded body” of the present invention and the “method of producing the silane crosslinkable rubber composition” of the present invention are collectively described below (in the description of the methods common to both, the methods may be collectively referred to as a production method of the present invention in some cases).

step (1): obtaining a silane crosslinkable rubber composition by melt-mixing, with respect to 100 parts by mass of a base rubber, 0.3 to 400 parts by mass of an inorganic filler, 1 to 15 parts by mass of a silane coupling agent, 0.01 to 0.6 parts by mass of an organic peroxide, and 0.0001 to 0.5 parts by mass of a silanol condensation catalyst

step (2): obtaining a molded body by molding the silane crosslinkable rubber composition obtained in the step (1)

step (3): obtaining a silane crosslinked rubber molded body by bringing the molded body obtained in the step (2) into contact with water

The step (1) has the step (a) and the step (c), when a whole of the base rubber is melt-mixed in the step (a). The step (1) has the step (a), the step (b) and the step (c), when a part of the base rubber is melt-mixed in the step (a).

step (a): preparing a silane master batch by melt-mixing a whole or part of a base rubber, an inorganic filler, a silane coupling agent and an organic peroxide at a temperature equal to or higher than a decomposition temperature of the organic peroxide

step (b): preparing a catalyst master batch by melt-mixing a remainder of the base rubber and a silanol condensation catalyst

step (c): melt-mixing the silane master batch, and the silanol condensation catalyst or the catalyst master batch

Here, “mixing” means an operation for obtaining a uniform mixture.

In the production method of the present invention, “base rubber” means the base rubber for forming the silane crosslinked rubber molded body or the silane crosslinkable rubber composition. Accordingly, in the production method of the present invention, 100 parts by mass of the base rubber only need to be contained in the silane crosslinking rubber composition obtained in the step (1). For example, the production method include, in the step (a), “an embodiment in which a total amount (100 parts by mass) of the base rubber is incorporated”, and “an embodiment in which a part of the base rubber is incorporated”. In “the embodiment in which a part of the base rubber is incorporated”, a remainder of the base rubber may be mixed as the carrier rubber in the step (b).

In the present invention, “a part of the base rubber” means the rubber to be used in the step (a) among the base rubbers, and a part of the base rubber itself (having a formulation identical with the formulation of the base rubber), a part of the component (the rubber component or the resin component) that composes the base rubber, or the component (for example, a total amount of a specific component in a plurality of components) in a part that composes the base rubber.

In addition, “a remainder of the base rubber” means a remaining rubber eliminating the part used in the step (a) among the base rubbers, and specifically includes a remainder (having a formulation identical with the formulation of the base rubber) of the base rubber itself, a remainder of the component that composes the base rubber, and a remaining component that composes the base rubber.

In the case where a part of the base rubber is incorporated in the step (a), the content of 100 parts by mass of the base rubber in the step (1) is the total amount of components to be mixed in the step (a) and the step (b).

Here, in the case where the remainder of the base rubber is incorporated in the step (b), the base rubber is incorporated in the step (a), preferably from 80 to 99 parts by mass, and further preferably from 94 to 98 parts by mass, and in the step (b), preferably from 1 to 20 parts by mass, and further preferably from 2 to 6 parts by mass.

In the step (1), the content of the ethylene-α-olefin rubber and the polypropylene-based resin in the base rubber is as described above. The composition can be molded, while keeping the excellent compression set and ozone resistance, at a higher linear speed by adding the polypropylene-based resin thereto.

In the step (1), the content of the organic peroxide is from 0.01 to 0.6 parts by mass, and preferably from 0.1 to 0.5 parts by mass, with respect to 100 parts by mass of the base rubber. If the content of the organic peroxide is less than 0.01 parts by mass, the grafting reaction during melt-mixing does not progress, and the silane coupling agents are condensed with each other, and the resultant product is unable to provide the molded body with the small and excellent compression set and the excellent ozone resistance in several cases. On the other hand, if the content thereof is over 0.6 parts by mass, most of the rubbers are directly crosslinked by a side reaction to form the aggregated substance to cause poor appearance in several cases. Thus, the grafting reaction can be performed in a suitable range by adjusting the content of the organic peroxide within this range. Thus, the composition that is excellent in the moldability without generating a gel-like aggregated substance, and can provide the silane crosslinked rubber molded body with the above-described characteristics can be obtained.

The content of the inorganic filler is from 0.3 to 400 parts by mass, preferably from 1 to 200 parts by mass, and more preferably from 3 to 100 parts by mass, with respect to 100 parts by mass of the base rubber. If the content of the inorganic filler is less than 0.3 parts by mass, the silane coupling agent is easily volatilized, and the grafting reaction and the crosslinking reaction of the silane coupling agent do not progress in several cases. As a result, when the composition is processed into the silane crosslinked rubber molded body, the excellent compression set, and further high tensile strength are not able to be obtained in several cases. On the other hand, if the content thereof is over 400 parts by mass, interaction between the rubbers is reduced, and the characteristics inherent to the rubber are adversely affected. Therefore, the excellent compression set, and further the high tensile strength are unable to be obtained, and in addition thereto, sufficient ozone resistance is also unable to be obtained in several cases. Furthermore, a load to a motor of the extruder or the like is increased, and a maximum extrusion linear speed during extrusion molding becomes slow in several cases.

The content of the silane coupling agent is from 1 to 15 parts by mass, preferably from 3 to 15 parts by mass, more preferably more than 4 parts by mass and 15 parts by mass or less, and further preferably more than 4 parts by mass and 10 parts by mass or less, with respect to 100 parts by mass of the base rubber.

If the content of the silane coupling agent is less than 1 part by mass, the crosslinking reaction does not sufficiently progress, and the excellent compression set is unable to be obtained in several cases. On the other hand, if the content thereof is over 15 parts by mass, the silane coupling agent is not adsorbed on the surface of the inorganic filler, and the silane coupling agent is volatilized during kneading, and such a case is not economical. In addition, the silane coupling agents that are not adsorbed thereon are condensed, and the aggregated substance or a burn is generated in the molded body, and the appearance is liable to be deteriorated.

If the content of the silane coupling agent is from 3 to 15 parts by mass, particularly over 4 parts by mass and 15 parts by mass or less, both the crosslinking reaction between the base rubbers and the condensation reaction between the silane coupling agents can be suppressed, and the silane crosslinked rubber molded body having fine appearance can be produced.

Details of a mechanism thereof are unknown yet, but are presumed as described below.

Specifically, in the step (a), with regard to the reactions caused by organic peroxide decomposition at the time of grafting of the silane coupling agent onto the base rubber, the grafting reaction between the silane coupling agent and the base rubber, and the condensation reaction between the silane coupling agents, having higher reaction rates than the reaction rate of the crosslinking reaction between the base rubbers, become dominant, when the content of the silane coupling agent is more than 4 parts by mass. Accordingly, the crosslinking reaction between the rubbers, which causes appearance roughness or aggregated substance, are not likely to occur. Thus, the crosslinking reaction between the base rubbers can be effectively suppressed depending on the content of the silane coupling agent. Thus, the appearance during molding is improved. In addition, the above-described defect caused by the crosslinking reaction between the base rubbers is minimized, and therefore it becomes difficult to cause poor appearance even if the extruder is stopped and then the operation is resumed. Thus, the silane crosslinked rubber molded body having favorable appearance can be produced with suppressing the crosslinking reaction between the base rubbers.

Meanwhile, in the step (a), the reaction rate of the condensation reaction between the silane coupling agents is also high. However, since a large amount of the silane coupling agent is bonded or adsorbed on the inorganic filler and immobilized thereon, the condensation reaction between the silane coupling agents that are bonded or adsorbed on the inorganic filler becomes difficult to occur. The condensation reaction between free silane coupling agents that are not bonded or adsorbed on the inorganic filler occurs in several cases. However, in the present invention, most of the silane coupling agents are bonded or adsorbed on the inorganic filler, and therefore does not lead to generation of the gel-like aggregated substance.

Thus, it is considered that the silane crosslinked rubber molded body having fine appearance can be produced by using a specific amount of the silane coupling agent.

The content of the silanol condensation catalyst is preferably from 0.0001 to 0.5 parts by mass, and more preferably from 0.001 to 0.3 parts by mass, with respect to 100 parts by mass of the base rubber. If the content of the silanol condensation catalyst is from 0.0001 to 0.5 parts by mass, the crosslinking reaction by the condensation reaction of the silane coupling agent easily progresses substantially uniformly, and the appearance, the tensile strength and the compression set of the silane crosslinked rubber molded body are excellent, and productivity is also improved. In other words, if the content of the silanol condensation catalyst is excessively low, the excellent compression set is unable to be obtained in several cases. On the other hand, if the content thereof is excessively large, the crosslinking reaction by the condensation reaction of the silane coupling agent becomes non-uniform, and the appearance and the productivity are deteriorated in several cases.

In the step (a), a whole or part of the base rubber, the inorganic filler, the silane coupling agent, and the organic peroxide are placed in a mixer in the above-described content, and the resultant mixture is melt-kneaded while heated to the temperature equal to or higher than the decomposition temperature of the organic peroxide, to prepare the silane master batch.

The temperature at which the above-mentioned components are melt-blended (also referred to as melt-mixed or kneaded) is a temperature equal to or higher than the decomposition temperature of the organic peroxide, and preferably a temperature of the decomposition temperature of the organic peroxide+1° C. to 80° C. It is difficult to unequivocally determine a melt-mixing temperature. However, to take one example, the temperature is preferably from 80 to 250° C., and further preferably from 100 to 240° C. The mixing temperature is preferably set after melting the base rubber. If the mixing temperature within the above-described range is applied, the above-described component is melted, and the organic peroxide is decomposed and acted thereon, and a necessary grafting reaction sufficiently progresses in the step (a). Other conditions also may be appropriately determined. For example, a mixing time only needs to be a time in which the grafting reaction of the silane coupling agent onto the base rubber at the above-described melting temperature sufficiently progresses, and is preferably from 5 minutes to 1 hour, for example.

A mixing method is not particularly limited, as long as the mixing method is a method ordinarily applied for rubber, plastic or the like. A mixing device may be appropriately selected depending on the mixing amount of the inorganic filler. As a mixing device, a single-screw extruder, a twin-screw extruder, a roll, a Banbury mixer, or various kneaders may be used. From the standpoint of the dispersibility of the rubber and the stability of the crosslinking reaction, an enclosed mixer such as Banbury mixer or various kneaders is preferable.

In addition, when the inorganic filler is mixed exceeding 100 parts by mass with respect to 100 parts by mass of the base rubber, the melt-mixing is preferably performed with a continuous kneader, a pressured kneader, or a Banbury mixer.

In the present invention, the phrase “whole or part of the base rubber, the organic peroxide, the inorganic filler, and the silane coupling agent are melt-mixed” does not specify the mixing order at the time of melt-mixing, and means that mixing may be made in any order. In other words, the mixing order in the step (a) is not particularly limited.

In addition, a method of mixing the base rubber is not particularly limited, either. For example, a base rubber that is premixed and prepared may be used, or each rubber component or each resin component may be separately mixed, respectively.

In the step (a), each component described above can be melt-mixed at one time, and it is preferable that the silane coupling agent be not introduced alone into the silane master batch, but be premixed with the inorganic filler, or the like, and then also be able to be mixed. The premixed silane coupling agent exists in such a manner of surrounding the surface of the inorganic filler, and a part or a whole thereof is adsorbed or bonded on the inorganic filler. In this manner, it makes it difficult for the silane coupling agent to volatilize upon a subsequent melt-mixing. Further, it is possible to prevent the condensation among that the silane coupling agents that are not adsorbed or bonded on the inorganic fillers, which makes melt-blending difficult. Furthermore, a desired shape can be obtained upon extrusion molding.

Specific examples of such a mixing method include a preferable method in which an organic peroxide, an inorganic filler and a silane coupling agent are premixed (dispersed) at a temperature lower than a decomposition temperature of the organic peroxide, preferably room temperature (25° C.), preferably for about 1 to 10 minutes, and then a mixture obtained and the base rubber are melt-mixed.

A method of mixing the inorganic filler, the silane coupling agent, and the organic peroxide is not particularly limited, and the organic peroxide may be simultaneously mixed with the inorganic filler or the like, or may also be mixed in any of stages of mixing the silane coupling agent with the inorganic filler.

For example, the organic peroxide may be mixed into the inorganic filler after being mixed with the silane coupling agent, or may be separately mixed into the inorganic filler separated from the silane coupling agent. In the present invention, it is preferable that the organic peroxide and the silane coupling agent be substantially simultaneously mixed. On the other hand, only the silane coupling agent may be mixed with the inorganic filler, and subsequently the organic peroxide may be added thereto, depending on production conditions. In other words, in the step (1), inorganic filler preliminarily mixed with the silane coupling agent can be used.

The organic peroxide may be a product prepared by being mixed with other components, or a single substance.

In a method of mixing the organic peroxide, the inorganic filler and the silane coupling agent, the rubber component or the resin component may exist as long as the above-described temperature lower than the decomposition temperature is kept.

Examples of the method of mixing the inorganic filler, the silane coupling agent, and the organic peroxide include mixing methods such as wet treatment and dry treatment. Specific examples thereof include a wet treatment in which the silane coupling agent is added to the inorganic filler being in a state dispersed in a solvent such as alcohol and water; a dry treatment in which both are added and mixed under heating or non-heating; and both of these methods. In the present invention, a dry treatment is preferable in which the silane coupling agent is added to the inorganic filler, preferably a dried inorganic filler, and mixed under heating or non-heating.

The premixing is preferably performed by using a mixer-type kneader such as a Banbury mixer and a kneader. In this manner, an excessive crosslinking reaction between the base rubbers can be prevented, and appearance becomes excellent. In addition, the premixing may be performed by using a mixer such as a Henschel mixer, or such ingredients may be manually mixed.

In wet mixing, bonding force of the silane coupling agent and the inorganic filler is increased, and therefore volatilization of the silane coupling agent can be effectively suppressed, but the grafting reaction onto the base rubber becomes hard to progress in several cases. On the other hand, in the dry mixing, bonding force of the silane coupling agent and the inorganic filler becomes comparatively weak, and therefore it becomes easy for grafting reaction to progress effectively and easy for the silanol condensation reaction to progress.

In a mixing method in which the above-described premixing is performed, subsequently, the mixture obtained and the whole or part of the base rubber are melt-mixing while heating the material at a temperature higher than the decomposition temperature of the organic peroxide.

In the step (a), the above-mentioned each component is preferably mixed without substantially mixing the silanol condensation catalyst. Thus, causing condensation reaction of the silane coupling agents is suppressed, melt-mixing is easily conducted, and a desired shape can be obtained at the time of extrusion molding. Here, the term “without substantially mixing” means that the silanol condensation catalyst unavoidably existing therein is not excluded, and may exist at a degree at which the above-mentioned problem due to silanol condensation of the silane coupling agent is not caused. For example, in the step (a), the silanol condensation catalyst may exist when the content is 0.01 parts by mass or less, with respect to 100 parts by mass of the base rubber.

In the step (1), the above-described additive, particularly the antioxidant or the metal inactivator may be mixed in any steps or with any components, but is preferably mixed with the carrier rubber. For example, if the antioxidant is added to the silane master batch in a large amount (for example, 1 part by mass or more), crosslinking inhibition is caused by a radical scavenging effect or the like, and as a result, the grafting reaction does not sufficiently progress in several cases.

As described above, the step (a) is carried out, and the silane master batch (also referred to as a silane MB) is prepared. The silane MB is used for producing a melt-mixture (silane crosslinkable rubber composition) to be prepared in the step (1), as mentioned later, preferably with the silanol condensation catalyst or a catalyst master batch as mentioned later. The silane MB contains the silane crosslinkable rubber (silane grafted rubber) in which the silane coupling agent is grafted onto the base rubber at a moldable degree in the step (2) as mentioned later.

In the production method of the present invention, subsequently, in the case where a part of the base rubber is melt-mixed in the step (a), the step (b) of preparing the catalyst master batch (also referred as a catalyst MB) by melt-mixing a reminder of the base rubber with the silanol condensation catalyst is carried out. Accordingly, in the case where a whole of the base rubber is melt-mixed in the step (a), the step (b) needs not to be carried out, and other resins and the silanol condensation catalyst may be mixed.

A mixing ratio of the rubber as the carrier rubber to the silanol condensation reaction catalyst is not particularly limited, but is preferably set so as to satisfy the above-described content in the step (1).

The mixing only needs to be performed by a method having a capability of uniformly performing mixing, and specific examples thereof include mixing (melt-mixing) performed under melting of a rubber. The melt-mixing can be performed in a manner similar to the melt-mixing in the above-described step (a).

For example, the mixing temperature is preferably applied from 80 to 250° C., and more preferably from 100 to 240° C. Other conditions such as a mixing time can be appropriately set.

In the step (b), other rubber components or resin components can be used as the carrier rubber in place of or in addition to the remainder of the base rubber. In other words, the catalyst MB may be prepared in the step (b) by melt-mixing the silanol condensation catalyst with the remainder of the base rubber in the case of melt-mixing of the part of the base rubber in the step (a) or with a rubber component or a resin component other than the base rubber used in the step (a). When the carrier rubber is any other rubber component or resin component, in view of capability of rapidly promoting silane crosslinking and difficulty in generating the aggregated substance during molding in the step (a), a content of incorporating any other rubber component or resin component is preferably from 1 to 50 parts by mass, further preferably from 2 to 30 parts by mass, and still further preferably from 4 to 20 parts by mass, with respect to 100 parts by mass of the base rubber.

In addition, in the step (b), an inorganic filler may be used. In this case, the content of the inorganic filler is not particularly limited, but is preferably 350 parts by mass or less with respect to 100 parts by mass of the carrier rubber. If the content of the inorganic filler is large, the silanol condensation catalyst is hard to be dispersed, and the crosslinking reaction becomes hard to progress.

The thus prepared catalyst MB is a mixture of the silanol condensation catalyst and the carrier rubber, and the inorganic filler to be added if desired.

The catalyst MB is used, together with the silane MB, for production of the silane crosslinkable rubber composition to be prepared in the step (1), as a master batch set.

In the production method of the present invention, subsequently, the step (c) of obtaining a melt-mixture by mixing the silane MB and either the silanol condensation catalyst or the catalyst MB, is carried out.

As the mixing method, any mixing method may be applied, as long as a uniform mixture can be obtained as mentioned above.

The mixing is basically similar to the melt-mixing in the step (a). The mixing is performed by mixing at a temperature at which the base rubber and the resin component are melted. The mixing temperature is appropriately selected according to the melting temperature of the base rubber or the carrier rubber. In the step (c), the melting temperature is preferably from 100 to 250° C., and more preferably from 120 to 220° C., for example. Other conditions such as a mixing (kneading) time may be appropriately set.

In the step (c), in order to avoid the silanol condensation reaction, it is preferable that the silane MB and the silanol condensation catalyst are not kept in a high temperature state for a long period of time in the state of being mixed.

This step (c) only needs to be a step in which the silane MB and the silanol condensation catalyst are mixed, to obtain a melt-mixture, and is preferably a step in which the catalyst MB containing the silanol condensation catalyst and the carrier rubber is melt-mixed with the silane MB.

In the step (1), the steps (a) to (c) can be carried out simultaneously or continuously.

As described above, the steps (a) to (c) (step (1)), namely, the method of producing the silane crosslinkable rubber composition of the present invention is carried out, and the silane crosslinkable rubber composition of the present invention is produced as a melt-mixture. This silane crosslinkable rubber composition contains the silane crosslinkable rubber in which the silane coupling agent is grafted onto the base rubber containing 61 to 100 mass % of ethylene-α-olefin rubber in which the diene content is 5 mass % or less, and with respect to 100 parts by mass of the base rubber, 0.3 to 400 parts by mass of the inorganic filler, and 0.0001 to 0.5 parts by mass of the silanol condensation catalyst.

The silane crosslinkable rubber contained in this silane crosslinkable rubber composition is a silane crosslinkable rubber in which the silane coupling agent is grafted onto the base rubber. In the silane crosslinkable rubber, the reaction site of the silane coupling agent may be bonded or adsorbed on the inorganic filler, but is not silanol condensed as mentioned later. Accordingly, the silane crosslinkable rubber at least includes the crosslinkable rubber in which the silane coupling agent that is bonded or adhered on the inorganic filler is grafted onto the base rubber, and the crosslinkable rubber in which the silane coupling agent that is not bonded or adhered on the inorganic filler is grafted onto the base rubber. In addition, the silane crosslinkable rubber may contain the silane coupling agent that is bonded or adhered on the inorganic filler, and the silane coupling agent that is not bonded or adhered on the inorganic filler. Further, the silane crosslinkable rubber may contain the rubber component that is unreacted with the silane coupling agent.

The silane crosslinkable rubber is preferably a rubber formed by causing the grafting reaction of 1 to 15 parts by mass of silane coupling agent, at a grafting ratio from 70 to 100 mass %, onto 100 parts by mass of the base rubber containing 61 to 100 mass % of ethylene-α-olefin rubber in which the diene content is 5 mass % or less.

A reaction proportion (also referred to as the grafting ratio) of the silane coupling agent upon performing the grafting reaction of the silane coupling agent onto the base rubber is not particularly limited, as long as the proportion is within the range in which advantageous effects of the invention are not adversely affected. In the present invention, it is difficult to unequivocally determine the grafting ratio, but for example, the grafting ratio according to the measuring method described in Examples as mentioned later is preferably from 70 to 100 mass % (from 0.7 to 15 parts by mass in a silane grafted amount), further preferably from 75 to 100 mass % (from 0.75 to 15 parts by mass in a silane grafted amount), and still further preferably from 80 to 100 mass % (from 0.8 to 15 parts by mass in a silane grafted amount). If the grafting ratio is from 70 to 100 mass %, the base rubber is sufficiently crosslinked, which is preferable to provide the molded body with the excellent characteristics as described above.

In the present invention, the grafting ratio can be set in a predetermined range depending on a kind or a content of the organic peroxide, a kind of the silane coupling agent, use of a closed-type mixer, or the like.

The silane crosslinkable rubber composition obtained in the step (1) is a non-crosslinked body in which no silane coupling agent is silanol condensed. Practically, if the silane coupling agent is melt-mixed in the step (c), part of crosslinking (partial crosslinking) is unavoidable, but the silane crosslinkable rubber composition to be obtained is to be formed into a material (in a non-crosslinked state or partially crosslinked state) in which the moldability having a capability of molding the composition is kept at least in the step (2).

In the method of producing a silane crosslinked rubber molded body of the present invention, subsequently, the step (2) and (3) are carried out.

In the method of producing a silane crosslinked rubber molded body of the present invention, the step (2) of obtaining a molded body by molding the melt-mixture thus obtained is performed. The step (2) only has to mold the melt-mixture, and the molding method and molding conditions can be appropriately selected depending on the form of the product (article) of the present invention. Specific examples of the molding method include extrusion molding using an extruder, injection molding using an injection molding machine, press molding using a press molding machine and molding using other molding machines. Extrusion molding is preferable in a case where the product of the present invention is an electric wire or an optical fiber cable.

When the molding step (2) is carried out by extrusion molding, a molding speed (extrusion speed) of the silane crosslinkable rubber composition of the present invention is not particularly limited, and can be set from 1 to 100 m/min in the linear speed, for example.

In addition, extrusion molding can also be performed at a high temperature. If a molding temperature is set at a high temperature, the extrusion molding at the above-described fast extrusion speed is facilitated. In particular, in the production method of the present invention, the excellent appearance can also be realized. When a temperature as the molding temperature is set at a high level, the temperature can be set at 150° C. or higher, and can also be set preferably at a level from 180 to 250° C., for example.

In addition, the step (2) can be carried out simultaneously or continuously with the step (c). In other words, specific examples of one embodiment of melt-mixing in the step (c) include an embodiment in which molding raw materials such as the silane MB and either the silanol condensation catalyst or the catalyst MB are melt-mixed upon melt molding, for example upon extrusion molding, or immediately before such molding. For example, pellets may be blended with each other at ordinary temperature or a high temperature, such as dry blend, and then placed (melt-mixed) in a molding machine, or the pellets may be blended, and then melt-mixed, re-pelletized, and then placed in a molding machine. More specifically, a series of steps can be employed in which a molded material with the silane MB and either the silanol condensation catalyst or the catalyst MB is melt-kneaded in a coating device, and subsequently, extruded and coated on a periphery of a conductor or the like, and molded into a desired shape.

As described above, the molded body of the silane crosslinkable rubber composition of the present invention is obtained. This molded body is unavoidable of partial crosslinking in a manner similar to the silane crosslinkable rubber composition, but is in a partially crosslinked state in which the moldability having a capability of molding the composition is kept in the step (2). Accordingly, the silane crosslinked rubber molded body of the present invention is a crosslinked or finally crosslinked molded body formed by carrying out the step (3).

In the method of producing the silane crosslinked rubber molded body of the present invention, a step is carried out in which the molded body obtained in the step (2) is contacted with water. Thus, the reaction site of the silane coupling agent is condensed, and the crosslinking reaction occurs. Specifically, the reaction site is hydrolyzed into silanol, hydroxy groups in the silanol are condensed with each other by the silanol condensation catalyst existing in the molded body, and the crosslinking reaction occurs. Thus, the silane crosslinked rubber molded body in which the silane coupling agent is silanol condensed and crosslinked can be obtained.

The treatment itself in this step (3) can be carried out according to an ordinary method. The condensation reaction between the silane coupling agents progresses just in storage at ordinary temperature. Accordingly, in the step (3), it is unnecessary to positively bring the molded body with water. In order to accelerate this crosslinking reaction, the molded body can also be contacted positively with moisture. For example, the method of positively contacting the molded body with water can be employed, such as immersion into warm water, placement in a wet heat bath, and exposure to high temperature water vapor. In addition, pressure may be applied in order to penetrate moisture thereinto on the above occasion. Such a technique is effective in a case of an electric wire having a large coating thickness, and also a molded body having a large volume.

As described above, the method of producing the silane crosslinked rubber molded body of the present invention is carried out, and the silane crosslinked rubber molded body is produced from the silane crosslinkable rubber composition of the present invention. This silane crosslinked rubber molded body contains, as mentioned later, a crosslinked rubber in which the silane crosslinkable rubber is crosslinked through the silane coupling agent. One embodiment of this silane crosslinked rubber molded body includes a silane crosslinked rubber and an inorganic filler. Here, the inorganic filler may be bonded with the silane coupling agent in the silane crosslinked rubber. Accordingly, this silane crosslinked rubber at least contains a crosslinked rubber in which a plurality of crosslinkable rubbers are bonded or adsorbed on the inorganic filler by the silane coupling agent, and bonded (crosslinked) through the inorganic filler and the silane coupling agent, and a crosslinked rubber in which the reaction sites of the silane coupling agents in the above-described crosslinkable rubbers are hydrolyzed and silanol condensation reacted with each other to be crosslinked through the silane coupling agents. In addition, the silane crosslinked rubber may have a mix of the bonding (crosslinking) through the inorganic filler and the silane coupling agent, and the crosslinking through the silane coupling agent. Further, the silane crosslinked rubber may contain a rubber component unreacted with the silane coupling agent and/or a non-crosslinked silane crosslinkable rubber.

Details of the reason of grafting in the production method of the present invention are unknown yet, but it is considered as described below. Specifically, when the base rubber is heat-kneaded with the inorganic filler and the silane coupling agent, in the presence of the organic peroxide, at a temperature equal to or higher than the decomposition temperature of the organic peroxide, the organic peroxide is decomposed to generate radical, and grafting onto the base rubber is caused by the silane coupling agent.

In addition, a reaction of forming a chemical bond due to covalent bonding of the silane coupling agent with the group such as the hydroxy group on the surface of the inorganic filler also partially occurs by heating on the above melt-mixing.

In the present invention, the final crosslinking reaction is performed in the step (3), and owing thereto, when the silane coupling agent is incorporated into the base rubber in a specific amount as mentioned above, the inorganic filer can be incorporated thereinto in a large amount without adversely affecting extrusion processability (moldability) during molding. Thereby the molded body can simultaneously have excellent appearance, the mechanical characteristics and the like while ensuring the excellent moldability.

In the method of producing the silane crosslinked rubber molded body of the present invention, the base rubber containing, in the above-described content, the ethylene-α-olefin rubber having a diene amount in the above-described range is mixed, molded and crosslinked by the above-described silane crosslinking method. Accordingly, the silane crosslinked rubber molded body simultaneously having the excellent high-temperature compression set and ozone resistance, and the excellent appearance can be produced.

In addition, in the method of producing the silane crosslinked rubber molded body of the present invention, the above-described base rubber is molded and crosslinked by the above-described silane crosslinking method, and therefore a need for the vulcanization facilities is eliminated in performing the crosslinking reaction, and productivity can be improved for a method of vulcanizing the EP rubber.

Further, in the production method of the silane crosslinked rubber molded body of the present invention, crosslinking of the base rubber can be suppressed during molding, and when necessary, the molding temperature can be set at a high temperature as described above, and the linear speed can be further set at a high level.

A mechanism of operation in the above-described process of the present invention is unknown yet, but it is assumed as described below. Specifically, by using the inorganic filler and the silane coupling agent before kneading and/or during kneading with the base rubber, the silane coupling agent is bonded with a group that can be chemically bonded of the inorganic filler by means of the reaction site of the silane coupling agent and kept on the inorganic filler. Or, the silane coupling agent is physically and chemically adsorbed onto pores or the surface of the inorganic filler, and kept thereon, without being bonded with the inorganic filler. Thus, the present invention can form a silane coupling agent bonded with the inorganic filler by strong bonding (as the reason therefor, for example, formation of chemical bond with the group that can be chemically bonded or the like on the surface of the inorganic filler is considered), and a silane coupling agent bonded therewith by weak bonding (as the reason therefor, for example, interaction due to hydrogen bond, interaction between ions, partial electric charges, or dipoles, action due to adsorption, or the like is considered). If the silane coupling agent is kneaded with the base rubber in the presence of the organic peroxide in this state, as mentioned later, the silane coupling agent is scarcely volatilized from the rubber composition (rubber kneaded product), and bonded with the site having a capability of causing the grafting reaction in the base rubber in the grafting reaction site that exists at another end. Thus, the silane crosslinkable rubber is formed in which the silane coupling agents having different bondings with the inorganic filler are graft reacted onto the base rubber.

In the silane coupling agent having strong bonding with the inorganic filler among the silane coupling agents, bonding with the inorganic filler is kept by the above-mentioned kneading, and also the grafting reaction site is graft reacted onto the site having a capability of causing the grafting reaction in the base rubber (radicalized site, in the rubber, generated by hydrogen radical abstraction by the radical generated by decomposition of the organic peroxide). In particular, when a plurality of the silane coupling agents are bonded on the surface of one inorganic filler particle through strong bonding, a plurality of the base rubbers are bonded through the inorganic filler particle. By these reactions or bondings, a crosslinked network through the inorganic filler spreads. In other words, a silane crosslinkable rubber is formed in which the silane coupling agents bonded with the inorganic filler is graft reacted onto the base rubber.

In the case of the silane coupling agent having strong bonding with the inorganic filler, the condensation reaction due to silanol condensation catalyst in the presence of water hardly occurs, and bonding with the inorganic filler is kept. The reason why the silanol condensation reaction hardly occurs is considered that bonding energy of the inorganic filler with the silane coupling agent is significantly high, and even under the silanol condensation reaction catalyst, no condensation reaction occurs. Thus, the bonding of the inorganic filler with the base rubber is formed, and crosslinking of the rubbers through the silane coupling agent is caused. By this, adhesion between the base rubber and the inorganic filler is consolidated, and the molded body that is excellent in tensile strength (mechanical strength) and a compression set is obtained.

In addition, a plurality of the silane coupling agents can be bonded on the surface of one inorganic filler particle, and high mechanical strength can be obtained.

As described above, it is considered that the silane coupling agent bonded with the inorganic filler by strong bonding contributes to improvement of tensile strength and suppressing of a compression set.

On the other hand, among the silane coupling agents, the silane coupling agent having weak bonding with the inorganic filler is released from the surface of the inorganic filler, and the grafting reaction site of the silane coupling agent reacts with the site having a capability of causing the grafting reaction of the base rubber, and the grafting reaction occurs. In other words, the silane crosslinkable rubber is formed in which the silane coupling agent released from the inorganic filler is graft reacted onto the base rubber. The silane coupling agent in the thus-formed grafted part is mixed with the silanol condensation catalyst afterward, and contacted with moisture to cause the condensation reaction (crosslinking reaction). The tensile strength of the silane crosslinked rubber molded body obtained by this crosslinking reaction is increased, and the silane crosslinked rubber molded body having the small compression set, particularly the small high-temperature compression set in addition to the heat resistance can be obtained. As described above, it is considered that the silane coupling agent bonded with the inorganic filler by weak bonding contributes to improvement of the degree of crosslinking that is improvement of the heat resistance, and suppressing of the compression set.

Incidentally, in the melt-mixing in the step (a), with regard to the rubber composed of the terpolymer, the crosslinking reaction of the diene constituent may also occur in the presence of the organic peroxide. However, when the diene content is within the above-described range, the grafting reaction of the silane coupling agent onto the rubber (other than the diene constituent) dominantly occurs. Particularly, in the above-described preferable pre-mixing method in the step (a), the silane coupling agent, the inorganic filler and the organic peroxide are preliminarily mixed. Accordingly, in addition to improvement of the characteristics based on the above-described silane crosslinking method, the compression set, particularly the high-temperature compression set can be suppressed, while ensuring the excellent ozone resistance, in the silane crosslinked rubber molded body obtained, even if the ethylene-α-olefin rubber having a low diene content is used. In addition, the excellent oil resistance is exhibited.

In particular, in the present invention, the crosslinking reaction due to the condensation using the silanol condensation catalyst in the presence of water in the step (3) is performed after the molded body is formed. Thus, workability in the steps up to forming the molded body is superb, in comparison with a method in which the extrusion molding and the crosslinking reaction are simultaneously performed, like a method described in Patent Literature 1, for example. In addition, the condensation reaction using the silanol condensation catalyst does not progress within the extruder in which moisture scarcely exists, and therefore the extrusion molding at a high temperature can be performed in the step (2). Accordingly, molding at higher temperature and a higher speed than those of a conventional molding can be performed.

Further, if the silane coupling agent is mixed with the inorganic filler by the production method of the present invention, as described above, condensation between the silane coupling agents is suppressed or the like, and the molded body having the excellent appearance is produced. Furthermore, in the present invention, when 3 to 15 parts by mass, in particular more than 4 parts by mass and 15 parts by mass or less of the silane coupling agent are mixed with the inorganic filler, as mentioned above, the crosslinking reaction between the rubbers during melt-kneading in the step (1), especially in the step (a), can be effectively suppressed. In addition, the silane coupling agent is bonded with the inorganic filler, and is hard to volatilize even during melt-kneading in the step (1), especially in the step (a), and the reaction between the free silane coupling agents can also be effectively suppressed. Further, the diene content in the ethylene-α-olefin rubber is 5 mass %, and the crosslinking reaction particularly between diene components can be prevented.

Accordingly, even if the extruder is once stopped and then the operation is resumed, it is hard to cause poor appearance, and a silane crosslinked rubber molded body having a favorable appearance can be produced. Here, the term “once stopped and then the operation is resumed” means, although conditions are influenced by the composition of the base rubber, processing conditions or the like, and cannot be unequivocally mentioned. For example, at a temperature of 190° C., the extruder can be stopped for up to 30 minutes, and preferably up to 90 minutes in terms of an interval. In addition, at a temperature of 200° C., the extruder can be stopped for up to 3 minutes, and preferably up to 10 minutes in terms of an interval.

The silane crosslinked rubber molded body of the present invention has at least the characteristic (same measuring methods in Examples) described below, and is excellent also in the appearance.

In other words, the silane crosslinked rubber molded body is excellent in the compression set in a wide temperature range.

For example, a compression set at 70° C. and a compression set at 150° C. both are preferably 45% or less, further preferably 40% or less, still further preferably 30% or less, and particularly preferably 20% or less. A lower limit thereof is not particularly limited, but a compression set at 70° C. and a compression set at 150° C. both are 10%, for example. As described above, the molded body exhibits the excellent compression set in the temperature range from 70 to 150° C.

The silane crosslinked rubber molded body is excellent in the ozone resistance. For example, even if the molded body is exposed in an atmosphere of an ozone concentration of 50 ppm and 40° C. for 24 hours or more, reduction of tensile elongation is small, and high durability against ozone is exhibited.

This silane crosslinked rubber molded body is preferably excellent also in the oil resistance as mentioned later.

From the silane crosslinkable rubber composition of the present invention, the silane crosslinked rubber molded body having the above-described excellent characteristics can be produced without needing the vulcanization facilities and with satisfactory productivity.

A silane crosslinked rubber molded article of the present invention may be a product including the silane crosslinked rubber molded body, or a product consisting essentially of the silane crosslinked rubber molded body. Specific examples of the product including the silane crosslinked rubber molded body include a product formed of a silane crosslinked rubber molded body and other members such as a support and a support frame. In the present invention, the product is used in the meaning including half-finished goods, parts and members.

Specific examples of the silane crosslinked rubber molded article of the present invention include coating materials for various industrial cables (including electric wires) and rubber mold materials (for example, automotive glass run channels, weather strips, rubber hoses, wiper blade rubbers, gaskets and rubber vibration insulators).

The silane crosslinked rubber molded article of the present invention is preferably processed into a product in which at least one of the characteristics of the excellent compression set and the high ozone resistance is required. Such a product is not particularly limited. Specific examples thereof include a product in which a compression set of 45% or less is required in the temperature range from 70 to 150° C., a product in which ozone resistance of 50% or less in reduction of tensile elongation is required even if the product is exposed in an atmosphere of an ozone concentration of 50 ppm and 40° C. for 24 hours, particularly for 300 hours, or a product in which the above-described compression set and the above-described ozone resistance are required. Further, the molded article is processed into a product in which oil resistance is required. Specific examples of the silane crosslinked rubber molded article of the present invention include outdoor industrial cables among coating materials for various industrial cables, and among rubber mold materials, automotive rubber mold materials, weather strips or gaskets.

The production method of the present invention is applicable to a production of a component part of or a member of a product, such as a product requiring excellent compression set, a product requiring the ozone resistance, a product requiring oil resistance, and a product using a rubber material.

As described above, according to the production method of the present invention, the silane crosslinked rubber molded body having the above-described excellent characteristics can be produced without needing the vulcanization facilities, and further with satisfactory productivity. Accordingly, the production method of the present invention can be particularly preferably applied to a product in which at least one of the characteristics of the excellent compression set and the high ozone resistance is required, or the like.

Among the above described product, the production method of the present invention is particularly preferably applied to production of electric wire and optical cable, and it can be formed as a coating material (an insulator, a sheath) thereof.

In the case where the product of the present invention is an extrusion-molded article such as the electric wire and the cable, such a product can be produced by coating the conductor or the like preferably by extruding the molding material on the periphery of the conductor or the like, while melt-kneading the molding material within the extruder (extrusion coating device) (step (c) and step (2)). These products may be produced by extrusion-coating the silane crosslinkable rubber composition that is added with the inorganic fillers (in a large amount), around a conductor or around a conductor that is prepared by attaching tensile strength fiber in a length or entwisting, using an extrusion coating device that is widely used, without using a specific instrument such as an electron beam crosslinking instrument and vulcanization facilities for a rubber. For example, as the conductor, a single wire, a stranded wire or the like of annealed copper can be used. Moreover, as the conductor, in addition to a bare wire, a tin-plated material or a material having an enamel-coated insulation layer can be used. A thickness of the insulation layer (coating layer formed of the silane crosslinkable rubber composition or the silane crosslinked rubber molded body of the present invention) formed around the conductor is not particularly limited, but is generally about 0.15 to about 5 mm.

### EXAMPLES

The present invention will be described in more detail based on examples given below, but the invention is not meant to be limited by these.

In Table 1, the numerical values for the content of the respective Examples and Comparative Examples are in terms of part by mass.

### Examples 1 to 7 and Comparative Examples 1 to 9

With regard to Examples 1 to 7 and Comparative Examples 1 to 9 each, operation was carried out by using the following components, and setting respective specifications to conditions shown in Table 1 each.

The details of each compound (component) in table 1 are described below.

### <Rubber Component>

### (EP Rubber)

EPM-1 and EPDM-1 to EPDM-5 were prepared by melt-mixing two or more kinds of EPM or EPDM at 150° C. for 10 minutes by using a Banbury mixer, and then being pelletized. Table 1 shows Mooney viscosity (ML (1+4) 125° C.), an ethylene content and a diene content (measured by infrared absorption spectroscopy) of EPM and EPDM each prepared.

“EPM-1” (ethylene-propylene rubber)

“EPDM-1” (ethlylene-propylene-ethylidene norbornene rubber)

“EPDM-2” (ethlylene-propylene-ethylidene norbornene rubber)

“EPDM-3” (ethlylene-propylene-ethylidene norbornene rubber)

“EPDM-4” (ethlylene-propylene-ethylidene norbornene rubber)

“EPDM-5” (ethlylene-propylene-ethylidene norbornene rubber)

“EPM-2” (EPT0045, trade name, manufactured by Mitsui Chemicals, Inc., ethylene-propylene rubber)

“EPDM-6” (NORDEL 3640, trade name, manufactured by Dow Chemical Japan Ltd., ethlylene-propylene-ethylidene norbornene rubber)

“EPDM-7” (NORDEL 4760P, trade name, manufactured by Dow Chemical Japan Ltd., ethlylene-propylene-ethylidene norbornene rubber)

“EPDM-8” (EPT3091, trade name, manufactured by Mitsui Chemicals, Inc., ethlylene-propylene-ethylidene norbornene rubber)

### <Resin Component>

### (Polypropylene-Based Resin)

“PM940M” (trade name, manufactured by SunAllomer Ltd., r-PP, MFR (230° C., 21.18 N) 30 g/10 minute)

### <Inorganic Filler>

“Aerosil 200” (Aerosil (registered trademark), manufactured by Japan Aerosil corporation, hydrophilic fumed silica, average primary particle diameter 12 nm)

“CRYSTALITE 5X” (trade name, manufactured by Tatsumori Ltd., crystalline silica, average primary particle diameter 1.4 μm)

“KISUMA 5L” (KISUMA (registered trademark), magnesium hydroxide, manufactured by Kyowa Chemical Industry Co., Ltd., average primary particle diameter 0.8 μm)

### <Silane Coupling Agent>

“KBM1003” (trade name, manufactured by Shin-Etsu Chemical Co., Ltd., vinyltrimethoxysilane)

### <Organic Peroxide>

“PERHEXA 25B” (trade name, manufactured by NOF CORPORATION, 2,5-dimethyl-2,5-di(tert-butylperoxy)hexane, half life temperature for 1 minute: 179.8° C.)

### <Silanol Condensation Catalyst>

“ADKSTAB OT-1” (trade name, manufactured by ADEKA CORPORATION, dioctyltin dilaurate)

In Examples 1 to 7 and Comparative Examples 1 to 5, a part of the EP rubber was used in the step (a), and a remainder (5 parts by mass) of the EP rubber was used as a carrier rubber of a catalyst MB in the step (b).

In the mass ratios shown in Table 1, an inorganic filler, a silane coupling agent, and an organic peroxide, were mixed at room temperature (25° C.). A silane MB was obtained by melt-mixing the mixture obtained with a base rubber containing a part of the EP rubber at a temperature (185° C.) equal to or higher than a decomposition temperature of the organic peroxide for 5 minutes by using a 2 L Banbury mixer (manufactured by Nippon Roll MFG. Co., Ltd.), and then discharging the resultant mixture at a material discharging temperature of 130° C., and being pelletized (step (a)). The silane MB obtained contains silane crosslinkable EP rubbers in which silane coupling agents were graft reacted onto the EP rubbers.

A remainder of the EP rubber and 0.1 parts by mass of silanol condensation catalyst were melt-mixed at 150° C. using a Banbury mixer (manufactured by Nippon Roll MFG Co., Ltd.), and the resultant mixture was discharged at a material discharging temperature of 130° C., to obtain a catalyst MB (Step (b)).

A dry blend material was obtained by dry blending the silane MB obtained in the step (a) and the catalyst MB obtained in the step (b) at 25° C. for 1 minute immediately above an extrusion molding machine for electric wire coating (25 in L/D (ratio of a screw effective length L to a diameter D), and 25 mmφ in a screw diameter).

### —Production of Electric Wire—

An electric wire precursor was produced by putting the dry blend material obtained in the above-described extrusion molding machine for electric wire coating, and extrusion-coating the material on a periphery of a 0.8 mmφ conductor (annealed copper wire) to be 1.2 mmφ in a finished outer diameter at a linear speed of 10 m/min under the extrusion temperature conditions described below.

With regard to the extrusion temperature conditions, for temperature control in a cylinder part in the extrusion molding machine for electric wire coating, the cylinder part was divided into 3 zones of C1, C2 and C3 from a feeder side toward a die side, and the zones of C1, C2 and C3 were set at 150° C., 170° C. and 190° C., respectively, and further a die temperature (molding temperature) was set at 200° C.

A silane crosslinkable rubber composition was prepared by melt-mixing the above-described dry blend material within the extrusion molding machine for electric wire coating before extrusion molding. This silane crosslinkable rubber composition contains the above-described silane crosslinkable EP rubber, and an inorganic filler and a silanol condensation catalyst each in a content shown in Table 1.

An electric wire was produced by bringing the thus obtained electric wire precursor into contact with water by allowing the precursor to stand under an environment of 25° C. and 50% RH for 24 hours. This electric wire had, as a coating material, a silane crosslinked rubber molded body containing a silane crosslinked EP rubber in which the EP rubber was crosslinked by the silane coupling agent, and the inorganic filler in the content shown in Table 1.

### —Production of Cylindrical Rubber Molded Article—

A melt strand having a diameter of about 35 mm was obtained in a manner similar to production of the above-described electric wire except that a dry blend material was extrusion-molded without using a conductor in production of the above-described electric wire. The melt strand obtained was cut and divided into pieces each having a length of about 15 mm, and the resultant pieces were compressed into a 29.0 mmφ and 12.5 mm-thick cylindrical mold with keeping a melt state, and were press pre-molded by using a press molding machine.

Then, the cylindrical mold was pre-heated at 150° C. for 10 minutes, a press pre-molded strand was put in the preheated cylindrical mold, and press-molded at 150° C. for 3 minutes at a pressure of 4 MPa by using the press molding machine. Thus, a 29.0 mmφ and 12.5 mm-thick cylindrical rubber molded article precursor was obtained.

A cylindrical rubber molded article was obtained by bringing the thus obtained cylindrical rubber molded article precursor into contact with water by allowing the precursor to stand in an atmosphere of 25° C. and 50% RH for 24 hours. This cylindrical rubber molded article was a silane crosslinked rubber molded body containing the silane crosslinked EP rubber in which the EP rubber was crosslinked by the silane coupling agent, and the inorganic filler each in the content shown in Table 1.

### Comparative Examples 6 to 9

### —Production of Electric Wire—

An organic peroxide in a proportion shown in Table 1 was kneaded into 100 parts by mass of EP rubber shown in Table 1 at 100° C. by using an 8 inch open roll and pelletized. An electric wire precursor was produced by extrusion-coating the pellets obtained on the above-described conductor by using the above-described extrusion molding machine for electric wire coating in a manner similar to production of the electric wire in Example 1.

Here, with regard to Comparative Examples 6 to 9, if the pellets were molded under extrusion temperature conditions similar to the conditions in Example 1, a crosslinking reaction was caused within the extrusion molding machine, and extrusion molding was unable to be performed, and even if extrusion molding was able to be performed, appearance of the electric wire precursor was adversely affected. Consequently, extrusion molding was performed by setting zones C1 to C3 in the extrusion molding machine to 90° C., and the die temperature to 100° C.

An electric wire was produced by crosslinking the electric wire precursor obtained, by passing the precursor through a 20 m-long chemical crosslinking tube set in a water vapor environment of a temperature of 200° C. and a pressure of 10 MPa.

### —Production of Cylindrical Rubber Molded Article—

A melt strand having a diameter of 35 mm was obtained in a manner similar to production of the above-described electric wire except that pellets were extrusion-molded under the extrusion temperature conditions described below without using a conductor in production of the above-described electric wire. Subsequently, the melt strand obtained was press pre-molded by using the same in a manner similar to “production of cylindrical rubber molded article” (same also in the heating temperature and the pressing pressure) in Example 1.

Then, the mold was pre-heated at 170° C. for 10 minutes, and then the press pre-molded strand was put in the pre-heated mold, and press-molded at 170° C. for 60 minutes at a pressure of 4 MPa by using a press molding machine. Thus, a 29.0 mmφ and 12.5 mm-thick cylindrical rubber molded article was obtained.

In each electric wire obtained, a grafting ratio was confirmed as described below, and the results are shown in Table 1.

In the present invention, the grafting ratio in a grafting reaction of the silane coupling agent onto the rubber was measured as described below. First, a test piece obtained by sampling a coating in an arbitrary place from each electric wire obtained was dried under a vacuum environment at 80° C. for 24 hours, and then mass of isolated silanol (unreacted silane coupling agent) was quantitatively determined from an absorption peak seen near 3750 cm⁻¹ by infrared absorption spectroscopy. Subsequently, the grafting ratio was calculated from the value obtained and mass (content) of the silane coupling agent actually used, according to Calculation Formula below.

Grafting ratio (mass %)={(mass actually used−mass of isolated silanol measured by infrared absorption spectroscopy)/(mass actually used)}×100

In addition, the test described below was conducted on each electric wire or each cylindrical rubber molded article obtained, and the results are shown in Table 1.

### <Appearance Test 1>

Appearance of each electric wire produced was visually observed and evaluated. In the evaluation of the appearance, a case where the appearance of the electric wire is excellent is deemed to be “A”, and a case where an aggregated substance was generated as many as the electric wire has a problem in the appearance in the product is deemed to be “D”.

### <Appearance Test 2 (Accelerated Gel or Aggregated Substance Promotion Test)>

In the above-described “production of electric wire”, appearance of each electric wire produced by once stopping extrusion coating and then resuming the operation during production of the electric wire precursor was visually observed and evaluated.

With regard to evaluation of the appearance, a case where no aggregated substance was confirmed in the appearance of the electric wire produced after elapse of 5 minutes from resumption of extrusion even if a screw of an extruder was once stopped under the above-described molding temperature to allow a molding material to dwell inside a cylinder for 10 minutes or more, and then extrusion molding was resumed during production of the electric wire precursor is deemed to be “A”, a case where no aggregated substance was confirmed in the appearance of the electric wire produced even by allowing the molding material to dwell inside the cylinder for 3 minutes or more and less than 10 minutes is deemed to be “B”, and a case where the aggregated substance was generated as many as the electric wire produced has a problem on the appearance in the product, if the molding material allowed to dwell thereinside for 3 minutes or more is deemed to be “D”.

In the present invention, in the appearance test 2, the evaluation “B” is a passable level in the test of the present invention.

### <Ozone Resistance>

Each electric wire was exposed under an atmosphere of an ozone concentration of 50 ppm and 40° C. for 24 hours, 100 hours and 300 hours, based on JIS K 6259. Tensile elongation of each electric wire before or after this exposure test was measured by the method described below, and ozone resistance was evaluated, by a reduction ratio of tensile elongation as calculated according to Formula below, based on the criteria described below.

The tensile elongation was measured at a gauge length of 20 mm and a tensile speed of 200 mm/min by using a tube-shaped piece prepared by extracting a conductor from each electric wire, based on JIS C 3005.

Reduction ratio (%) of tensile elongation=[tensile elongation after exposure for each time/tensile elongation before exposure]×100

With regard to the evaluation criteria, a case where the reduction ratio in each exposure time is 50% or more was judged to be passable, and a case where the reduction ratio was passable up to 24 hours in the exposure time is deemed to be “C”, a case where the reduction ratio was passable up to 100 hours is deemed to be “B”, and a case where the reduction ratio was passable up to 300 hours is deemed to be “A”. A case where the reduction ratio was not passable in the exposure time of 24 hours is deemed to be “D”.

In the present invention, in the ozone resistance, the evaluation “C” is a passable level in the test of the present invention.

### <Compression Set>

A compression set was measured, by using the cylindrical rubber molded article produced in each Example, based on Method A of JIS K 6262. Compression by 25% (compression ratio: 25%) was applied to the cylindrical rubber molded article in a thickness direction by using a compression apparatus equipped with two compression plates and a spacer (thickness: 75% of a thickness of the cylindrical rubber molded article), and the cylindrical rubber molded article was heated at 70° C. or 150° C., and kept for 22 hours with keeping the state. Then, the compression was released at 23° C., and the resultant molded article was cooled for 30 minutes (final temperature: 23° C.), and then the thickness of the cylindrical rubber molded article was measured.

The compression set was calculated from the thickness of the cylindrical rubber molded article before or after the compression according to Formula below, and evaluated based on the evaluation criteria described below.

Formula:CS=[(t₀−t₂)/(t₀−t₁)]×100

where, CS denotes a compression set (%),

t₀ denotes a thickness (mm) of a cylindrical rubber molded article before compression (original thickness),

t₁ denotes a thickness (mm) of a spacer, and

t₂ denotes a thickness (mm) of a cylindrical rubber molded article after compression (thickness after 30 minutes from removal from a compression apparatus).

A case where a compression set at 70° C. and a compression set at 150° C. each were 20% or less is deemed to be “A”, a case where each was over 20% and 30% or less is deemed to be “B”, a case where each was over 30% and 45% or less is deemed to be “C”, and a case where each was over 45% is deemed to be “D”.

In the present invention, in the compression set, the evaluation “C” is a passable level in the test of the present invention.

### <Oil Resistance Test>

A tube-shaped piece prepared by extracting the conductor from each electric wire was immersed into ASTM Type II mineral oils heated at 120° C. for 18 hours. Tensile elongation of each electric wire before or after this immersion test was measured by the method described below, and oil resistance was evaluated, by a reduction ratio of the tensile elongation calculated from Formula below, based on the criteria described below.

The tensile elongation was measured at a gauge length of 20 mm and a tensile speed of 200 mm/min by using the tube-shaped piece, based on JIS C 3005.

Reduction ratio (%) of tensile elongation=[(tensile elongation after immersion)/(tensile elongation before immersion)]×100

With regard to the evaluation criteria, a case where the reduction ratio of the tensile elongation was 60% or more was judged to be “A”. In addition, a case where the reduction ratio was 50% or more and less than 60% is deemed to be “B”, and a case where the reduction ratio was less than 50% is deemed to be “D”, and deemed to be not passable.

In the present invention, in the oil resistance, the evaluation “B” is a passable level in the test of the present invention.

TABLE 1

| | | The | The | Mooney | | | | | | | | | |
|---|---|---|---|---|---|---|---|---|---|---|---|---|---|
| | | diene | ethylene | viscosity | This invention | | | | | | | | |
| | | content | content | (125° C.) | 1 | 2 | 3 | 4 | 5 | | 6 | 7 | |
| EP rubber | EPM-1 | 0 | 55 | 40 | 100 | | | | | | 80 | 100 | |
| | EPDM-1 | 1.5 | 55 | 40 | | 100 | | | | | | | |
| | EPDM-2 | 2 | 55 | 40 | | | 100 | | | | | | |
| | EPDM-3 | 4 | 55 | 40 | | | | 100 | | | | | |
| | EPDM-4 | 5 | 55 | 40 | | | | | 100 | | | | |
| | EPDM-5 | 5.5 | 55 | 40 | | | | | | | | | |
| | EPM-2 | 0 | — | — | | | | | | | | | |
| | EPDM-6 | 1.8 | — | — | | | | | | | | | |
| | EPDM-7 | 4.9 | — | — | | | | | | | | | |
| | EPDM-8 | 5.4 | — | — | | | | | | | | | |
| PP | PM940M | | | | | | | | | | 20 | | |
| Inorganic filler | Aerosil 200 | | | | 5 | 5 | 5 | 5 | 5 | | 5 | | |
| | CRYSTALITE 5X | | | | | | | | | | | | |
| | KISUMA 5L | | | | | | | | | | | 100 | |
| Silane coupling agent | KBM1003 | | | | 6 | 6 | 6 | 6 | 6 | | 6 | 6 | |
| Organic peroxide | PERHEXA 25B | | | | 0.12 | 0.12 | 0.12 | 0.12 | 0.12 | | 0.12 | 0.12 | |
| Silanol condensation | ADKSTAB OT-1 | | | | 0.1 | 0.1 | 0.1 | 0.1 | 0.1 | | 0.1 | 0.1 | |
| catalyst | | | | | | | | | | | | | |
| The grafting ratio (mass %) | | | | | 81 | 81 | 81 | 81 | 81 | | 74 | 80 | |
| Evaluation | Appearance 1 | | | | A | A | A | A | A | | A | A | |
| | Appearance 2 | | | | A | A | A | B | B | | A | A | |
| | Ozone resistance | | | | A | B | B | B | C | | B | A | |
| | Oil resistance (120° C., 18 hr) | | | | A | A | A | B | B | | A | A | |
| | Compression set (%) | | (70° C.) | | C | C | B | B | B | | B | C | |
| | | | (150° C.) | | C | C | B | B | B | | B | C | |
| | | The | The | Mooney | | | | | | | | | |
| | | diene | ethylene | viscosity | Comparative Example | | | | | | | | |
| | | content | content | (125° C.) | 1 | 2 | 3 | 4 | 5 | 6 | 7 | 8 | 9 |
| EP rubber | EPM-1 | 0 | 55 | 40 | | 100 | 100 | 100 | 100 | | | | |
| | EPDM-1 | 1.5 | 55 | 40 | | | | | | | | | |
| | EPDM-2 | 2 | 55 | 40 | | | | | | | | | |
| | EPDM-3 | 4 | 55 | 40 | | | | | | | | | |
| | EPDM-4 | 5 | 55 | 40 | | | | | | | | | |
| | EPDM-5 | 5.5 | 55 | 40 | 100 | | | | | | | | |
| | EPM-2 | 0 | — | — | | | | | | 100 | | | |
| | EPDM-6 | 1.8 | — | — | | | | | | | 100 | | |
| | EPDM-7 | 4.9 | — | — | | | | | | | | 100 | |
| | EPDM-8 | 5.4 | — | — | | | | | | | | | 100 |

| PP | PM940M | | | | | | | | | | |
|---|---|---|---|---|---|---|---|---|---|---|---|
| Inorganic filler | Aerosil 200 | | 5 | 0.2 | | 5 | 5 | | | | |
| | CRYSTALITE 5X | | | | 410 | | | | | | |
| | KISUMA 5L | | | | | | | | | | |
| Silane coupling | KBM1003 | | 6 | 6 | 6 | 0.9 | 16 | | | | |
| agent | | | | | | | | | | | |
| Organic peroxide | PERHEXA 25B | | 0.12 | 0.12 | 0.12 | 0.12 | 0.12 | 0.12 | 0.12 | 0.12 | 0.12 |
| Silanol condensation | ADKSTAB OT-1 | | 0.1 | 0.1 | 0.1 | 0.1 | 0.1 | | | | |
| catalyst | | | | | | | | | | | |
| The grafting ratio (mass %) | | | 81 | 57 | 80 | 80 | 73 | — | — | — | — |
| Evaluation | Appearance 1 | | A | A | A | A | D | A | A | A | A |
| | Appearance 2 | | D | A | A | A | D | A | B | D | D |
| | Ozone resistance | | D | A | D | A | A | A | C | C | D |
| | Oil resistance (120° C., 18 hr) | | D | A | B | A | A | D | A | B | D |
| | Compression set (%) | (70° C.) | B | D | D | D | B | D | C | C | B |
| | | (150° C.) | B | D | D | D | B | D | D | D | C |

As is obvious from the results shown in Table 1, the silane crosslinked rubber molded articles (electric wires or cylindrical rubber molded articles) produced in Examples 1 to 7 all were excellent in the appearance, the ozone resistance and the compression set, and further preferably had excellent oil resistance. In addition, in each Example, all were able to be extrusion-molded at a high temperature of 200° C. Moreover, even if the extruder was once stopped and then the operation was resumed, the electric wires each having excellent appearance were able to be produced.

In contrast, with regard to Comparative Example 1 in which EPDM the diene content of which was over 5 mass % was used, both the ozone resistance and the oil resistance were insufficient. If the extruder was once stopped and then the operation was resumed, the appearance was reduced.

In addition, with regard to Comparative Example 2 in which the content of the inorganic filler was small, the compression set was large, and with regard to Comparative Example 3 in which the content of the inorganic filler was large, both the ozone resistance and the compression set were poor.

Further, with regard to Comparative Example 4 in which the content of the silane coupling agent was small, the compression set was large, and with regard to Comparative Example 5 in which the content of the silane coupling agent was large, the appearance was poor.

With regard to Comparative Examples 6 to 8 in which a rubber crosslinking method being not the silane crosslinking method is applied, all were large in the compression set, and with regard to Comparative Example 6, the oil resistance was also insufficient. On the other hand, with regard to Comparative Example 9 in which a rubber crosslinking method being not the silane crosslinking method was applied, and the EP rubber the diene content of which was over 5 mass % was used, both the ozone resistance and the oil resistance were poor. In addition, with regard to Comparative Examples 8 and 9, the appearance test 2 was poor.

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2015-041471 filed in Japan on Mar. 3, 2015, and Patent Application No. 2015-232032 filed in Japan on Nov. 27, 2015, each of which is entirely herein incorporated by reference.

1. A silane crosslinkable rubber composition, comprising:
a silane crosslinkable rubber in which a silane coupling agent is grafted onto a base rubber containing 61 to 100 mass % of ethylene-α-olefin rubber having a diene content of 5 mass % or less, and
with respect to 100 parts by mass of the base rubber, 0.3 to 400 parts by mass of inorganic filler, and 0.0001 to 0.5 parts by mass of silanol condensation catalyst.

2. The silane crosslinkable rubber composition according to claim 1, wherein the diene content is 2 mass % or less.

3. The silane crosslinkable rubber composition according to claim 1, wherein the silane crosslinkable rubber composition is obtained by melt-mixing, with respect to 100 parts by mass of the base rubber, 0.3 to 400 parts by mass of the inorganic filler, 1 to 15 parts by mass of the silane coupling agent, 0.01 to 0.6 parts by mass of the organic peroxide, and 0.0001 to 0.5 parts by mass of the silanol condensation catalyst.

4. The silane crosslinkable rubber composition according to claim 1, wherein the inorganic filler is at least one kind selected from the group consisting of metal hydrate, talc, clay, silica, and carbon black.

5. The silane crosslinkable rubber composition according to claim 1, wherein the base rubber contains 1 to 30 mass % of polypropylene-based resin.

6. The silane crosslinkable rubber composition according to claim 1, wherein the content of the silane coupling agent is from 3 to 15 parts by mass with respect to 100 parts by mass of the base rubber.

7. A silane crosslinked rubber molded body obtained by molding the silane crosslinkable rubber composition according to claim 1, and then bringing the resultant material into contact with water.

8. A silane crosslinked rubber molded article including the silane crosslinked rubber molded body according to claim 7.

9. A method of producing a silane crosslinkable rubber composition, comprising:
step (1): obtaining the silane crosslinkable rubber composition by melt-mixing, with respect to 100 parts by mass of a base rubber containing 61 to 100 mass % of ethylene-α-olefin rubber having a diene content of 5 mass % or less, 0.3 to 400 parts by mass of inorganic filler, 1 to 15 parts by mass of silane coupling agent, 0.01 to 0.6 parts by mass of organic peroxide, and 0.0001 to 0.5 parts by mass of silanol condensation catalyst,
wherein the step (1) comprising a step (a) and a step (c) below, provided that, when a part of the base rubber is melt-mixed in the step (a), the step (1) comprising a step (a), a step (b) and a step (c);
step (a): preparing a silane master batch by melt-mixing a whole or part of the base rubber, the inorganic filler, the silane coupling agent and the organic peroxide at a temperature equal to or higher than a decomposition temperature of the organic peroxide;
step (b): preparing a catalyst master batch by melt-mixing a remainder of the base rubber and the silanol condensation catalyst; and
step (c): melt-mixing the silane master batch, and the silanol condensation catalyst or the catalyst master batch.

10. A method of producing a silane crosslinked rubber molded body, comprising the following steps (1), (2) and (3):
step (1): obtaining a silane crosslinkable rubber composition by melt-mixing, with respect to 100 parts by mass of a base rubber containing 61 to 100 mass % of ethylene-α-olefin rubber having a diene content of 5 mass % or less, 0.3 to 400 parts by mass of inorganic filler, 1 to 15 parts by mass of silane coupling agent, 0.01 to 0.6 parts by mass of organic peroxide, and 0.0001 to 0.5 parts by mass of silanol condensation catalyst,
step (2): obtaining a molded body by molding the silane crosslinkable rubber composition obtained in the step (1); and
step (3): obtaining a silane crosslinked rubber molded body by bringing the molded body obtained in the step (2) into contact with water,
wherein the step (1) comprises a step (a) and a step (c) below, provided that, when a part of the base rubber is melt-mixed in the step (a), the step (1) comprises the step (a), a step (b) and the step (c);
step (a): preparing a silane master batch by melt-mixing a whole or part of the base rubber, the inorganic filler, the silane coupling agent and the organic peroxide at a temperature equal to or higher than a decomposition temperature of the organic peroxide;
step (b): preparing a catalyst master batch by melt-mixing a remainder of the base rubber and the silanol condensation catalyst; and
step (c): melt-mixing the silane master batch, and the silanol condensation catalyst or the catalyst master batch.
